(19) United States
(12) Patent Application Publication
(10) Pub. No.: US 2026/0265469 A1
(43) Pub. Date: Sep. 10, 2026

(54) LOW VISCOSITY POLYURETHANE ACRYLATE HYBRID COMPOSITION FOR RIGID AND TOUGH PRODUCTS

(71) Applicant: Dow Global Technologies LLC, Midland, MI (US)

(72) Inventors: Abhishek Dhyani, Lake Jackson, TX (US); Abhishek U. Shete, Iowa Colony, TX (US); Bindu Krishnan, Lake Jackson, TX (US)

(21) Appl. No.: 19/153,662

(22) PCT Filed: Feb. 15, 2024
(86) PCT No.: PCT/US2024/015964

§ 371 Date: Aug. 5, 2025

Related U.S. Application Data
(60) Provisional application No. 63/487,308, filed on Feb. 28, 2023.

(51) Int. Cl. C08J 3/24; B29C 45/00; B29C 45/02; B29K 67/00; B29K 75/00

(52) U.S. Cl. CPC C08J 3/246; B29C 45/0001; B29C 45/02; B29K 2067/06; B29K 2075/00; C08J 2375/08; C08J 2433/08; C08J 2433/10

(57) ABSTRACT

Polyurethane acrylate hybrid compositions may include a polyurethane phase and a polyacrylate phase, the polyurethane phase containing a reaction product of: an isocyanate component including one or more isocyanate compounds, and an isocyanate-reactive component comprising one or more polyether polyols; and the poly(meth)acrylate phase containing a reaction product of: one or more (meth)acrylate monomers having an acrylate functionality in the range of 2 to 8, and one or more initiators, wherein the (meth)acrylate monomers and initiators are independently present in at least one of the isocyanate component, the isocyanate-reactive component, or a third component that is introduced upon combination of the isocyanate component and isocyanate-reactive component; and wherein the polyurethane phase and the polyacrylate phase form an interpenetrating network. Methods include forming polyacrylate hybrid compositions and composites containing same.

### FIELD

Embodiments relate to polyurethane acrylate hybrid compositions containing an interpenetrating network of polyurethane and polyacrylate phases and methods of using same.

### INTRODUCTION

PU-based elastomers find wide application in a number of fields, but traditional routes to increase the tensile strength are limited. Fillers are often to increase PU tensile properties, but are also associated with unfavorable increases in viscosity and elongation at break. Other approaches include the addition of plasticizers and impact modifiers that can improve the elongation and toughness in some systems, while offering a tradeoff in reduced modulus at ambient and elevated temperatures and hardness. Additionally, plasticizers may leach out the material during the lifetime of the materials (especially at elevated temperatures), which may generate volatile organic components and raise safety concerns. Thus, options for PU-based materials having of high strength (stiff and tough), high softening point (i.e., glass transition temperature or T_{g}), and low viscosity during application are limited, particularly in applications such as electric vehicle (i.e, EV) battery potting/gap filling and EV battery tray insulation layers, and/or composites manufactured using pultrusion process.

### SUMMARY

Embodiments disclosed herein include polyurethane acrylate hybrid compositions having a polyurethane phase and a polyacrylate phase, the polyurethane phase containing a reaction product of: an isocyanate component including one or more isocyanate compounds, and an isocyanate-reactive component comprising one or more polyether polyols; and the poly(meth)acrylate phase containing a reaction product of: one or more (meth)acrylate monomers having an acrylate functionality in the range of 2 to 8, and one or more initiators, wherein the (meth)acrylate monomers and initiators are independently present in at least one of the isocyanate component, the isocyanate-reactive component, or a third component that is introduced upon combination of the isocyanate component and isocyanate-reactive component; and wherein the polyurethane phase and the polyacrylate phase form an interpenetrating network. Methods include forming polyacrylate hybrid compositions and composites containing same.

In another aspect, embodiments disclosed herein include methods of preparing a polyurethane acrylate hybrid composition including, combining to form a mixture: an isocyanate component including one or more isocyanate compounds; an isocyanate-reactive component comprising one or more polyether polyols; and an optional third component; wherein one or more (meth)acrylate monomers having an acrylate functionality in the range of 2 to 8, and one or more initiators are, independently, present in at least one of the isocyanate component, the isocyanate-reactive component, or the optional third component; and reacting the mixture to form the polyurethane acrylate hybrid composition.

In another aspect, embodiments disclosed herein include methods of preparing a composite article, including: disposing on a substrate or extruding through a die chamber, a polyurethane acrylic hybrid composition prepared by combining to form a mixture: an isocyanate component including one or more isocyanate compounds; an isocyanate-reactive component comprising one or more polyether polyols; an optional third component, and a reinforcement material; wherein one or more (meth)acrylate monomers having an acrylate functionality in the range of 2 to 8, and one or more initiators are, independently, present in at least one of the isocyanate component, the isocyanate-reactive component, or the optional third component; curing the mixture to produce the composite article.

### DETAILED DESCRIPTION

Embodiments relate to polyurethane (PU) acrylate hybrid compositions containing an interpenetrating network of polyurethane and polyacrylate phases. PU acrylate hybrid compositions may exhibit low viscosity (<600 cP) prior to curing and, upon curing, exhibit enhanced storage modulus and impact resistance. Methods may include reacting an isocyanate component and an isocyanate-reactive component in the presence of an orthogonal polymerization of (meth)acrylate monomer(s) and initiator to generate the PU acrylate hybrid composition.

As used herein, the term “interpenetrating polymer network” (i.e, IPN) is intended to mean an entangled network of two (or more) polymer phases obtained by simultaneous and/or sequential polymerization and/or crosslinking of two or more types of monomers to generate a mixed polymer product having a single and/or multiple glass transition temperature range from two or more entangled but independent crosslinked networks. Interpenetrating networks are distinguishable from a mixture of preformed polymer networks as containing individual polymer phases that are at least partially interlaced on a molecular scale, but which are not covalently bonded to each other and cannot be separated without breaking and/or disruption and/or degradation. The IPN with two independent networks in same material is also referred as dual and/or double network in some literature.

PU acrylate hybrid compositions may be prepared through the orthogonal polymerization of the respective PU and poly(meth)acrylate phases. PU acrylate hybrid compositions may be generated by reacting an isocyanate component with an isocyanate-reactive component, while the acrylate phase is generated through the reaction of one or more (meth)acrylate monomers and a free radical initiator system. The (meth)acrylate monomers and free radical initiator may be disposed in the isocyanate and/or isocyanate-reactive component, or combined as a third component upon combination of the isocyanate and isocyanate-reactive components. The (meth)acrylate monomers and free radical initiator system may be combined in a single component or divided among one or more components.

The PU phase within the PU acrylate hybrid composition may include an isocyanate component containing one or more isocyanate compounds, such as polymeric isocyanates, aromatic isocyanates, or carbodiimide-modified isocyanates. Isocyanate compounds may be monomeric, oligomeric, prepolymers, and the like. The isocyanate component can include, for example, one or more isocyanate and/or polyisocyanate compounds. Isocyanate components may include isocyanate compounds having a nominal functionality of ≥1.5, or ≥2.0.

The isocyanate component may include an isocyanate compound having a number average molecular weight of 150 g/mol to 750 g/mol. In some cases, the isocyanate compound can have a number average molecular weight from a low value of 150 g/mol, 200 g/mol, 250 g/mol or 300 g/mol to an upper value of 350 g/mol, 400 g/mol, 450 g/mol, 500 g/mol or 750 g/mol. The number average molecular weight values reported herein are determined by end group analysis, gel permeation chromatography, and other methods as is known in the art. The isocyanate compound can be monomeric and/or polymeric, as are known in the art.

The isocyanate component may include on or more of aliphatic polyisocyanate, cycloaliphatic polyisocyanate, araliphatic polyisocyanate, aromatic polyisocyanate, and the like. Examples of isocyanates include, but are not limited to, polymethylene polyphenylisocyanate; toluene 2,4-/2,6-diisocyanate (TDI); methylenediphenyl diisocyanate (MDI, including its isomers); polymeric and prepolymeric MDI; triisocyanatononane (TIN); naphthyl diisocyanate (NDI); 4,4′-diisocyanatodicyclohexyl-methane; 3-isocyanatomethyl-3,3,5-trimethylcyclohexyl isocyanate (isophorone diisocyanate, IPDI); tetramethylene diisocyanate; hexamethylene diisocyanate (HDI); 2-methyl-pentamethylene diisocyanate; 2,2,4-trimethylhexamethylene diisocyanate (THDI); dodecamethylene diisocyanate; 1,4-diisocyanatocyclohexane; 4,4′-diisocyanato-3,3′-dimethyl-dicyclohexylmethane; 4,4′-diisocyanato-2,2-dicyclohexylpropane; 3-isocyanatomethyl-1-methyl-1-isocyanatocyclohexane (MCI); 1,3-diisooctylcyanato-4-methylcyclohexane; 1,3-diisocyanato-2-methylcyclohexane; and combinations thereof, among others. In addition to the isocyanates mentioned above, partially modified polyisocyanates including uretdione, isocyanurate, carbodiimide, uretonimine, allophanate or biuret structure, and combinations thereof, among others, may be utilized.

Isocyanate compounds may include isocyanate prepolymers resulting from reaction of an isocyanate-reactive compound with a molar excess of an isocyanate compound or polymeric isocyanate compound under conditions that do not lead to gelation or solidification, the isocyanate prepolymers can have a higher average isocyanate equivalent weight of >140 g/eq. Formation of isocyanate prepolymers is known in the art, and may include reacting (1) at least one isocyanate compound and (2) at least one polyol compound. Isocyanate prepolymers may be described by an isocyanate index, defined as the ratio of isocyanate groups to isocyanate-reactive groups (such as OH groups) multiplied by 100. Isocyanate prepolymers disclosed herein may have an isocyanate index, defined as the equivalents of isocyanate divided by the total equivalents of isocyanate-reactive hydrogen containing materials, multiplied by 100) in a range of from 30 to 400, 40 to 300, or 40 to 200.

Examples of commercial isocyanates include, but are not limited to, polyisocyanates under the trade names VORANATE™, VORATRON™, PAPI™, VORAFORCE™ and ISONATE™ available from Dow Chemical Company.

PU acrylate hybrid compositions may include an isocyanate component at a percent by weight (wt %) ranging from 15 wt % to 80 wt %, 20 wt % to 80 wt %, or 20 wt % to 70 wt %.

Isocyanate-reactive components may include a polyol blend containing one or more polyether polyols, including mixtures of high and low molecular weight (MW) polyether polyols, one or more (meth)acrylate monomers, initiators, catalysts, surfactants, fillers, and other additives. Isocyanate-reactive components may have a viscosity according to ASTM D2983-21 of 600 cP or less, 500 cP or less, or be in a range of 40 cP to 500 cP.

Isocyanate-reactive components may include one or more polyether polyols prepared by polyaddition of alkylene oxides such as propylene oxide and/or ethylene oxide onto polyhydroxy functional starter compounds in the presence of catalysts known in the art. Polyether polyols may be prepared from one or more starter compound(s) and one or more alkylene oxides, for example, ethylene oxide, propylene oxide, and/or butylene oxide. Starter compounds may include molecules having 1 to 8 hydroxyl groups per molecule such as ethylene glycol, propylene glycol, diethylene glycol, dipropylene glycol, triethylene glycol, tripropylene glycol, 1,4-butanediol, 1,6-hexanediol, bisphenol A, glycerol, trimethylolpropane, pentaerythritol, sugars and sugar alcohols such as sucrose and sorbitol, and the like. Polyether polyols may also include polyols reacted with polyethers formed from copolymers of alkylene oxides, including block copolymers and polyethers “capped” with ethoxy and/or propoxy.

Polyether polyols may have a hydroxyl equivalent weight, defined as the weight average molecular weight of the polyol divided by the average number of hydroxyl groups or the average hydroxyl functionality of the molecule, in a range of 30 Da to 5000 Da, or 30 Da to 4000 Da.

Polyether polyols may include a mixture of low MW polyether polyols and high MW polyether polyols, where “high MW” refers to polyether polyols having a number average molecular weight of 500 Da or more and “low MW” refers to polyether polyols having a number average molecular weight of less than 500 Da. The high MW polyether polyols and low MW polyether polyols may independently be selected from polyether polyols having hydroxyl functionality in the range of 1 to 8. The weight ratio of high MW:low MW polyether polyols may be in the range of 5:1 to 1:5, 5:1 to 1:1, 4:1 to 1:4, 3:1 to 1:3, or 3:1 to 1:1.

The isocyanate-reactive component may include at least one polyether polyol present at a percent by weight of the isocyanate-reactive component (wt %) from 40 wt % to 95 wt %, 45 wt % to 95 wt %, or 50 wt % to 90 wt %. In formulations containing mixtures of high MW and low MW polyether polyols, wt % ranges may be applied to each type of polyol a combined total.

The isocyanate-reactive component may include one or more (meth)acrylate monomers having an unsaturated double bond functionality ranging from 2 to 8, and number average molecular weights of 100 Da or more. As used herein, use of “(meth)” in conjunction with various acrylate or acrylate species indicates that the scope of the specification covers both the acrylate and/or methacrylate variations of the referenced compound.

Acrylate and methacrylate monomers include (meth)acrylate functionalized polyols and polyalkylene glycols (e.g., polyethylene glycol). Suitable (meth)acrylate monomers include ethylene glycol di(meth)acrylate, hexanediol di(meth)acrylate, nonanediol di(meth)acrylate, butylene glycol di(meth)acrylate, triethylene glycol di(meth)acrylate, tetraethylene glycol di(meth)acrylate, polyethylene glycol di(meth)acrylate i.e., (PEG) di(meth)acrylate, dipropylene glycol di(meth)acrylate, trimethylolpropane tri(meth)acrylate, ethoxylated trimethylolpropane tri(meth)acrylate, glycerol tri(meth)acrylate, pentaerythritol tri(meth)acrylate, pentaerythritol tetra(meth)acrylate, tris(2-hydroxyl-ethyl) isocyanurate triacrylate, ditrimethylolpropane tetra(meth)acrylate, and alkoxylated polyol derived di or polyacrylates, such as propoxylated neopentyl glycol diacrylate or propoxylated glycerol triacrylate, neopentyl glycol di(meth)acrylate, combinations of these, and the like. Preferred reactive diluents are diacrylates such as 1,6 hexanediol diacrylate, 1,9 nonanediol diacrylate, 1,4 butanediol acrylate, tricyclodecane dimethanol diacrylate, cyclohexane dimethanol diacrylate, cis/trans 1,3/1,4 cyclohexanedimethanol diacrylate, alkoxylated cyclohexane dimethanol diacrylates, tripropylene glycol diacrylate and the like. More preferred reactive diluents include propoxylated neopentyl glycol diacrylate, propoxylated glyceryl triacrylate and tripropylene glycol diacrylate, and the like. In some cases, monofunctional (meth)acrylate monomers and monofunctional (meth)acrylate functionalized polyols may be added in addition to any of the above (meth)acrylate monomers.

Isocyanate-reactive component may include one or more acrylate monomers at a percent by weight (wt %) in a range of 5 wt % to 90 wt %, or 10 wt % to 80 wt %. The poly(meth)acrylate phase prepared from the (meth)acrylate monomers and the initiator is present at a percent by weight (wt %) of the PU acrylate hybrid composition in a range of 2 wt % to 50 wt %, 2.5 wt % to 50 wt %, or 5 wt % to 50 wt %.

PU acrylate hybrid compositions may include one or more initiators (e.g., free radical initiators) added to the isocyanate, isocyanate-reactive component, or as a third component introduced upon combination of the isocyanate and isocyanate-reactive components. The initiator includes but is not limited to peroxides, persulfides, peroxycarbonates, peroxyboric acid, quinones azo compounds or other suitable radical initiators that can initiate curing of a double bond-containing compound. Initiators may be active, or activatable by redox, thermal- or photo-initiation, or combinations of any of those. Suitable initiators include azo compounds, such as 2,2-azobisisobutyronitrile (AIBN), and the like, or peroxides such as tert-butyl peroxybenzoate, butyl 4,4-di(tert-butylperoxy) valerate, di-tert-amyl peroxide, dicumyl peroxide, di(tert-butylperoxyisopropyl)benzene, 2,5-dimethyl-2,5-di(tert-butylperoxyl) hexane, tert-butyl cumyl peroxide, 2,5-dimethyl-2,5-di(tert-butylperoxyl) hexyne-3, di-tert-butyl peroxide, 3,6,9-triethyl-3,6,9-trimethyl-1,4,7-triperoxonane, isopropylcumyl hydroperoxide, 1,1,3,3-tetramethylbutyl hydroperoxide, cumyl hydroperoxide, tert-butyl hydroperoxide, and the like, or ketones such as benzophenone, camphorquinone, thioxanthone, and the like. Examples of a commercially available initiators are LUPEROX® DI, LUPEROX® 10, and LUPEROX® P from Arkema, IRGACURE® 819, IRGACURE® 651, and IRGACURE® 819 from Ciba, among other commercially available radical initiator(s) and/or generator(s). Additionally, one or more photo-sensitive radical initiator undergoing either Norrish Type I or Norrish Type II mechanism can be used in either isocyanate and/or isocyanate-reactive component and/or as a separate component. Polyurethane acrylate hybrid compositions may include one or more initiators at a percent by weight (wt %) of the isocyanate and/or isocyanate-reactive components ranging from 0.1 wt % to 6 wt %, or 0.1 wt % to 5 wt %.

Isocyanate-reactive components may include one or more catalysts for enhancing polyurethane polymerization to generate the PU acrylate hybrid composition. Catalysts may be used individually or as a catalyst package containing multiple catalysts, such as gelling catalysts, blowing catalysts, and trimerization catalysts. Gelling and blowing catalysts may be differentiated by a tendency to favor either the urethane (gel) reaction, in the case of the gelling catalyst, or the urea (blow) reaction, in the case of the blowing catalyst. A trimerization catalyst may be utilized to promote the isocyanurate forming reaction in the compositions. The catalyst package can also be added as a separate stream into the reaction mixture of isocyanate and isocyanate-reactive composition.

Gelling catalysts include organometallic compounds, cyclic tertiary amines and/or long chain amines, e.g., that contain several nitrogen atoms and combinations thereof. Organometallic compounds include organotin compounds, such as tin (II) salts of organic carboxylic acids, e.g., tin (II) diacetate, tin (II) dioctanoate, tin (II) diethylhexanoate, and tin (II) dilaurate, and dialkyltin (IV) salts of organic carboxylic acids, e.g., dibutyltin diacetate, dibutyltin dilaurate, dibutyltin maleate and dioctyltin diacetate. Bismuth salts of organic carboxylic acids may also be utilized as the gelling catalyst, such as, for example, bismuth octanoate. Cyclic tertiary amines and/or long chain amines include dimethylbenzylamine, triethylenediamine, and combinations thereof. Examples of a commercially available gelling catalysts are POLYCAT® 8, DABCO® 33-LV, and DABCO® T-12 from Evonik, among other commercially available gelling catalysts.

Blowing catalysts include may bis-(2-dimethylaminoethyl) ether; pentamethyldiethylenetriamine, triethylamine, tributyl amine, N,N-dimethylaminopropylamine, dimethylethanolamine, N,N,N′,N′-tetra-methylethylenediamine, and combinations thereof, among others. An example of a commercial blowing catalyst is POLYCAT® 5, from Evonik, among other commercially available blowing catalysts.

Trimerization catalysts may include any such catalysts known in the art. Examples of trimerization catalysts include N,N′,N″-tris(3-dimethylaminopropyl) hexahydro-S-triazine; N,N-dimethylcyclo-hexylamine; 1,3,5-tris(N,N-dimethylaminopropyl)-s-hexahydrotriazine; [2,4,6-tris (dimethylaminomethyl) phenol]; potassium acetate, potassium octoate; tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 carbon atoms to 20 carbon atoms, and combinations thereof, among others. Some commercially available trimerization catalysts include, for example, DABCO® TMR-2, DABCO® TMR-20, DABCO® TMR-30, DABCO® TMR-7, DABCOR K 2097; DABCOR K15, POLYCAT® 41, and POLYCAT® 46, each from Evonik, among other commercially available trimerization catalysts.

Catalysts may include a “latent catalyst” or “delayed catalyst,” which is defined as a catalyst compound that is of low catalytic activity or is relatively inactive at ambient temperatures, and which becomes more catalytically active, such as by disassociation, decoordination, ring opening, ionization, or tautomerization upon heating to effect catalysis of least one of the chemical reactions involved in making a PU foam. Ambient temperatures may range 15° C. to 32° C., where room temperature is often around 23° C.

Latent/delayed catalysts can be gelling, blowing, and/or trimerization types of catalysts in terms of their function in the foaming process. The latent catalyst is often a subset of tertiary amine gelling catalysts (e.g., delayed action tertiary amine based on 1,8-Diazabicyclo[5.4.0]undec-7-ene) that include acid salts, phenolic salts, or complexes of a tertiary amine catalyst where the acid or phenolic is often a carboxylic acid or phenol species, but not limited to, such as formic acid, acetic acid, propionic acid, 2-ethylhexanoic acid, phenoxyacetic acid, gluconic acid, tataric acid, citric acid, phenol, nonylphenol, diisopropyl phenol, and the like; and mixtures thereof. Some useable commercially available latent catalysts include, for example, DABCO® TMR-30, POLYCAT® SA2 LE, POLYCAT® SA-1/10, DABCO® 8154, NIAX™ A-107, NIAXTMC-31, NIAXTMC-225, JEFFCAT™ ZF-54, JEFFCAT™ LED-204; and mixtures thereof.

The catalyst or catalyst package may be present in the PU acrylate hybrid composition at a percent by weight (wt %) ranging from 0.1 wt % to 10 wt %, or 1 wt % to 7 wt %. In some cases, a catalyst package may be added to the isocyanate component and/or the isocyanate-reactive component in amount sufficient to provide the mixture with the corresponding weight percentages above.

PU acrylate hybrid compositions may include one or more fillers and/or inorganic reinforcement materials including fiberglass, fiber, ceramics, silica, calcium carbonate, kaolin, talc, alumina, alumina trihydrate (ATH), hollow particulates (e.g., glass, ceramic, polymer), and the like. In some cases, reinforcement materials include any one or more of glass fibers, carbon nanotubes, carbon fibers, polyester fibers, natural fibers, aramid fibers, nylon fibers, basalt fibers, boron fibers, silicon carbide fibers, asbestos fibers, whiskers, hard particles, metal fibers, surface-functionalized derivatives of thereof, and the like.

Fillers and/or inorganic reinforcement may be surface-functionalized with a treatment agent to modify hydrophobicity or hydrophilicity, or introduce one or more functional groups such as alkyl, hydroxyl, amine, vinyl, allyl, acrylate, methacrylate, hydrosilyl (i.e., SiH), and the like.

Treatment agents may vary depending on the nature of the filler or inorganic reinforcement. For example, silica surfaces may be modified with a silane treating agent to incorporate functional groups that react with, or modify the compatibility of, the filler the PU acrylate hybrid formulation.

One or more fillers may be added at a percent by weight (wt %) of the composition ranging from 0 wt % to 85 wt %, or 5 wt % to 80 wt %, or 10 wt % to 75 wt %. In some cases, fillers may be added to the isocyanate component and/or the isocyanate-reactive component in amount sufficient to provide the mixture with the corresponding weight percentages above. In some cases, articles may be formed from PU acrylate compositions, by combining isocyanate and isocyanate-reactive components, dispensing the combined mixture on a reinforcement material, and processing the resulting composite by a suitable process (e.g., pultrusion, molding, etc.).

PU acrylate hybrid compositions may include one or more silicone or organic defoamers added at a percent by weight (wt %) of the polyurethane acrylate hybrid composition in a range of 0.05 wt % to 5 wt %, 0.1 wt % to 1.5 wt %, or 0.1 wt % to 1 wt %.

The isocyanate-reactive component may also contain one or more additives including blowing agents, surfactants, crosslinkers, plasticizers, fillers, smoke suppressants, fragrances, reinforcements, dyes, colorants, pigments, preservatives, odor masks, physical blowing agents, chemical blowing agents, flame retardants, internal mold release agents, biocides, antioxidants, UV stabilizers, antistatic agents, moisture scavenger, thixotropic agents, adhesion promoters, cell openers, and the like.

While formulation components have been disclosed individually, it is envisioned that component elements (e.g., compounds in isocyanate or isocyanate-reactive components) may be included, excluded, or combined in any manner or subcombination utilizing the above mentioned concentration ranges and nested subranges.

PU acrylate hybrid compositions may be formed generally by combining the isocyanate component and the isocyanate-reactive component to form a mixture by a suitable method (e.g., mixing, injection), while the compounds that form the (meth)acrylate phase (i.e., (meth)acrylate monomers, initiator) are present, independently, in the isocyanate or isocyanate-reactive component or both. The (meth)acrylate phase-forming compounds may also be added as a third component upon or during the mixing of the isocyanate and isocyanate-reactive components and before polyurethane formation.

PU acrylate hybrid compositions may be used in any suitable process for developing articles and composites, including molding, injection, vacuum infusion, pultrusion, and the like. In one method, PU acrylate hybrid compositions may be prepared by combining the isocyanate component, the isocyanate-reactive component, and (meth)acrylate monomers and initiators to form a mixture; processing the mixture in a mold to produce a molded article; and demolding the molded article.

Methods of preparing a polyurethane acrylate hybrid composition may include combining to form a mixture: an isocyanate component including one or more isocyanate compounds; an isocyanate-reactive component comprising one or more polyether polyols; and an optional third component; wherein one or more (meth)acrylate monomers having an acrylate functionality in the range of 2 to 8, and one or more initiators are, independently, present in one or more of the isocyanate component, the isocyanate-reactive component, or the optional third component; and reacting the mixture to form the polyurethane acrylate hybrid composition.

PU acrylate hybrid compositions may be used to prepare a composite part. For the preparation of the composite part, the polyurethane-poly(meth)acrylate reactive composition is mixed with a reinforcement material or injected into the reinforcement material, e.g., by vacuum assisted resin transfer molding (VARTM) and/or resin transfer molding (RTM). In some cases, methods of preparing composite articles may include disposing on a substrate or extruding through a die chamber, a polyurethane acrylic hybrid composition prepared by combining to form a mixture: an isocyanate component including one or more isocyanate compounds; an isocyanate-reactive component comprising one or more polyether polyols; an optional third component; and a reinforcement material; wherein one or more (meth)acrylate monomers having an acrylate functionality in the range of 2 to 8, and one or more initiators are, independently, present in at least one of the isocyanate component, the isocyanate-reactive component, or the optional third component; and curing the mixture to produce the composite article.

Composite articles prepared using the inventive PU acrylate hybrid compositions may include one or more reinforcement materials at a percent by weight (wt %) in a range of 1 wt % to 90 wt %, 30 wt % to 90 wt %, 40 wt % to 85 wt %, or 40 wt % to 80 wt %.

Composite articles prepared using the inventive PU acrylate hybrid compositions may further include one or more core materials that facilitates the molding and weight reduction of a composite material. Core materials may include polystyrene foams, polyester PET foams, polyimide PMI foams, polyvinyl chloride foam, metal foams, celluloses, woods such as balsa wood, and the like.

Polyurethane acrylate hybrid compositions may produce articles and composites having excellent mechanical properties, e.g., enhanced impact resistance and modulus, high thermal deformation temperature, high tensile and flexural strength, high resistance to fatigue, high ductility, and low shrinkage rate. Articles and composites may be used in automotive and/or stationary storage applications such as electric vehicle (i.e, EV) battery potting and/or encapsulation (completely or partially), gap fillers, thermal barriers, and EV battery tray insulation layers, and composites manufactured using pultrusion process. Articles and composites may also be used in the manufacture of wind generator blades, wind generator nacelle housings, watercraft propeller blades, hulls, interior and exterior automobile decorative parts, automobile bodies, radomes, machinery structural members, decorative parts and structural members for architectures and bridges, and the like.

Composite articles prepared using the inventive PU compositions may include one or more reinforcement materials at a percent by weight (wt %) in a range of 1 wt % to 90 wt %, 30 wt % to 90 wt %, 40 wt % to 85 wt %, or 40 wt % to 80 wt %.

### EXAMPLES

The following examples are provided to illustrate the embodiments of the invention, but are not intended to limit the scope thereof. Table 1 provides the materials used in the following examples.

TABLE 1
Materials used in the examples

| Component | Description | Source |
|---|---|---|
| Low MW | Polyether polyol (3 functional) with a hydroxyl equivalent | Dow |
| polyol | weight of 85 Da | |
| High MW | A propylene glycol-initiated polyether polyol (2 functional) | Dow |
| polyol | with a hydroxyl equivalent weight of 510 Da | |
| Moisture | Moisture scavenger paste; 50 weight percent zeolith powder in | Dow |
| scavenger | castor oil | |
| Catalyst - 1 | A delayed action tertiary amine based on 1,8- | Evonik |
| | Diazabicyclo[5.4.0]undec-7-ene (i.e. DBU). | |
| Catalyst - 2 | A mixture of 33 wt. % triethylenediamine dissolved in 67 wt. % | Evonik |
| | dipropylene glycol. | |
| Defoamer | Polysiloxane defoamer | BYK |
| Radical | Azobisisobutyronitrile | Sigma |
| Initiator | | |
| Acrylate | Triethylene glycol di(meth)acrylate | TCI, |
| monomer | | America |
| Filler | Calcium carbonate filler | Imerys |
| Isocyanate | A polymeric MDI having a nominal functionality of 2.7 and an | Dow |
| | approximate NCO content by weight of 31% | |

### Example 1: Properties of Polyurethane Acrylate Hybrid Compositions

In this example, inventive samples containing polyurethane acrylate hybrid compositions were assayed for physical properties over comparative examples containing polyurethane alone

Sample formulations are shown in Table 2. Samples were prepared by blending formulation components by DAC 600.1 FVZ-K speedmixer in the proportions specified in Table 2, with all units in grams unless otherwise specified. A and B side components were prepared separately and mixed. The mixture was poured into a mold and kept at 23° C. until tack free. The plaques were then demolded, and the test specimen shapes were cut accordingly. The test specimens were then allowed to post cure at 100° C. for 1 hour to ensure formation of the polyurethane and acrylate IPN.

TABLE 2
Sample formulations

| | SI | | | | | | |
|---|---|---|---|---|---|---|---|
| Component # | Units | CE1 | CE2 | CE3 | IE1 | IE2 | IE3 |
| Low MW polyol | g | 15.58 | 13.63 | 10.18 | 15.25 | 11.6 | 8.65 |
| High MW polyol | g | 3.9 | 3.41 | 2.55 | 3.82 | 2.9 | 2.16 |
| Moisture scavenger | g | 1.56 | 1.43 | 1.07 | 1.55 | 1.15 | 1.15 |
| Catalyst-1 | g | 0.39 | 0.34 | 0.26 | 0.38 | 0.3 | 0.22 |
| Catalyst-2 | g | 0.02 | 0.02 | 0.02 | 0.02 | 0.05 | 0.05 |
| Defoamer | g | 0.4 | 0.09 | 0.18 | 0.39 | 0.3 | 0.22 |
| Initiator | g | 0 | 0 | 0 | 0.1 | 0.25 | 0.46 |
| Acrylate monomer | g | 0 | 0 | 0 | 5 | 12.5 | 22.5 |
| Filler | g | 0 | 10 | 20 | 0 | 0 | 0 |
| Sum of Side B | | 21.9 | 28.9 | 34.3 | 26.5 | 29.1 | 35.4 |
| Isocyanate (Side A) | g | 28.16 | 21.09 | 15.76 | 23.5 | 20.95 | 14.6 |
| Total (Side A + B) | g | 50 | 50 | 50 | 50 | 50 | 50 |
| Weight % Methacrylate in final material | | 0 | 0 | 0 | 10 | 25 | 45 |
| Weight % PU in final material | | 100 | 100 | 100 | 90 | 75 | 55 |
| Weight % Methacrylate in B Side | | 0 | 0 | 0 | 19 | 43 | 64 |
| Weight % Iso in final material | | 56 | 42 | 32 | 47 | 42 | 29 |

Sample formulations were then tested for a number of characteristics and performance (property #I-XI).

Viscosity (property #I): Viscosity of the preformulated part B side for each formulation (except CE3 and IE3) was measured using Brookfield DV-II+Pro viscometer. The rotational speed and torque were adjusted in accordance with ASTM D2983 for the viscosity range for each sample at 25° C. For preformulated Side B of sample CE3, TA Instruments AR 2000 Rheometer was used with 54 mm cone-plate geometry and 450 micron gap as per ASTM D4440-15 for viscosity measurement. Sample temperature was kept at 25° C. and shear rate applied was 1/s. For preformulated Side B of sample IE3), kinematic viscosity was measured at 25° C. using Ostwald's viscometer with ASTM D445.

Elongation at break (property #II), Ultimate tensile strength (property #III), Tensile modulus (property #IV) were determined using ASTM D1708-18 standard on MTS machine. The cured samples of approximately 3 mm thickness post molding (and min 2 days of aging at ASTM conditions) to test. The microtensile samples were further cut or punched in a dog-bone shape.

Shear modulus in torsion mode (property #V to VII) and glass transition temperature (property #VIII) were obtained by dynamic mechanical analysis (DMA) with ASTM D5279-21 on an Advanced Rheometric Expansion System (ARES-G2) from TA Instruments equipped with liquid nitrogen environmental control and torsion rectangular fixtures. A rectangular sample were cut from the pottant plaques prepared in metal molds (A and B) as per the procedure described above at 2 mm thickness and cut to dimensions of 45 mm length, and 12.8 mm width. The sample length was lined up axial to the torsional axis, and the DMA was performed in torsional mode. The temperature was increased from −70° C. to 200° C. at a ramp rate of 3° C./min. The frequency of testing was 1 Hz at 0.05% torsional strain, with an axial tensile force of 0.098 N applied to keep sample taut, and at a data collection interval of 30 sec per point. The major output from the characterization identified were the storage modulus in shear modulus (G′) over the temperature range and peak of Tan & curve was assigned as glass transition temperature (T_{g}).

Izod impact test (IX) was determine by molding samples into 45 mm length and 12.7 mm width and 3 mm thickness. The samples were notched at a notch length of 2.54 mm at the center of the sample. For notching, the CEAST Notchvis automatic notcher (POR-TL-090) was used. The Model 92T with the Model 892 Impact Display System was used to measure impact resistance in accordance with ASTM D256 (Method for Determining the Izod Pendulum Impact Resistance of Plastics) at 23° C. and 50% relative humidity.

TABLE 3
Testing results for comparative (CE1-CE3) and inventive samples (IE1-IE3).

| Property # | Tested Property | Target | CE1 | CE2 | CE3 | IE1 | IE2 | IE3 |
|---|---|---|---|---|---|---|---|---|
| I | Side B viscosity (cP) at 25° C. | ≤600 | 815 | 4220 | 207,000 | 441 | 178 | 50 |
| II | Elongation at break (%) | ≥3 | 9.4 | 4.3 | 4.7 | 10.6 | 10 | 3.6 |
| III | Ultimate tensile strength (MPa) | ≥20 | 41 | 16.4 | 17.6 | 40 | 88 | 25 |
| IV | Tensile modulus at 25° C. (MPa) | >500 | 574 | 652 | 657 | 509 | 1531 | 1335 |
| V | Storage modulus via DMA at | >600 | 800 | 438 | 533 | 849 | 1087 | 860 |
| | 25° C. (MPa) | | | | | | | |
| VI | Storage modulus via DMA at | >200 | 710 | 151 | 171 | 741 | 948 | 666 |
| | 50° C. (MPa) | | | | | | | |
| VII | Storage modulus via DMA at | >100 | 594 | 31.7 | 53.4 | 541 | 742 | 418 |
| | 75° C. (MPa) | | | | | | | |
| VIII | Glass transition temperature | >80 | 144 | 71 | 57 | 124 | 141 | 129 |
| | via DMA (° C.) | | | | | | | |
| IX | Izod Impact Strength at 23° C. | >2.1 | 2.1 | 2.09 | 1.91 | 4.14 | 3.91 | N/A |
| | (kJ/m²) | | | | | | | Break |

Comparative examples (CE1-3) have a B Side viscosity of >600 cP (property #I) and the modulus (property #V) of the pure PU elastomer (CE 1) is enhanced from the use of the filler (CE 2-3) with a corresponding increase in viscosity. IE1-IE3 have relatively low viscosity (<600 cP) and exhibit enhanced storage modulus (property #V-VII). While increasing isocyanate content can enhance modulus, the inclusion of methacrylate monomer IE1-IE3 provides an increase of 6-40% over the CE1 (and 80-140% over CE2 and CE3) at similar or lower isocyanate concentrations. Further, there is a roughly 2× increase in impact strength over PU. The impact strength for IE1 and IE2 are ~4.2 KJ/m² and 3.9 KJ/m², respectively, compared to 2.1 kJ/m² or less for CE1-CE3.

While the foregoing is directed to exemplary embodiments, other and further embodiments may be devised without departing from the basic scope thereof, and the scope thereof is determined by the claims that follow.

What is claimed is:

1. A polyurethane acrylate hybrid composition, comprising a polyurethane phase and a polyacrylate phase,
the polyurethane phase comprising a reaction product of:
an isocyanate component including one or more isocyanate compounds, and
an isocyanate-reactive component comprising one or more polyether polyols wherein the isocyanate-reactive component has a viscosity of 600 cP or less; and
the poly(meth)acrylate phase comprising a reaction product of:
one or more (meth)acrylate monomers having an acrylate functionality in the range of 2 to 8, and one or more initiators,
wherein the (meth)acrylate monomers and initiators are independently present in at least one of the isocyanate component, the isocyanate-reactive component, or a third component that is introduced upon combination of the isocyanate component and isocyanate-reactive component; and
wherein the polyurethane phase and the polyacrylate phase form an interpenetrating network.

2. The composition of claim 1, wherein the poly(meth)acrylate phase is present at a percent by weight (wt %) of the PU acrylate hybrid composition in a range of 5 wt % to 45 wt %.

3. The composition of claim 1, wherein the polyether polyol comprises a mixture of one or more low molecular weight polyether polyols having a number average molecular weight of 500 Da or less, and one or more high molecular weight polyether polyols having a number average molecular weight of 500 Da or more.

4. The composition of claim 1, wherein the polyether polyol comprises a mixture of one or more low molecular weight polyether polyols having a number average molecular weight of 500 Da or less, and one or more high molecular weight polyether polyols having a number average molecular weight of 500 Da or more at a weight ratio of 5:1 to 1:1.

5. The composition of claim 1, wherein the one or more polyether polyols have a hydroxyl equivalent weight ranging from 30 Da to 4000 Da.

6. The composition of claim 1, further comprising a reinforcement material at a percent by weight (wt %) of 5 wt % to 80 wt %.

7. (canceled)

8. An article prepared from the polyurethane acrylate hybrid composition of claim 1.

9. A method of preparing a polyurethane acrylate hybrid composition comprising, combining to form a mixture:
an isocyanate component including one or more isocyanate compounds;
an isocyanate-reactive component comprising one or more polyether polyols, wherein the isocyanate-reactive component has a viscosity of 600 cP or less; and
an optional third component;
wherein one or more (meth)acrylate monomers having an acrylate functionality in the range of 2 to 8, and one or more initiators are, independently, present in at least one of the isocyanate component, the isocyanate-reactive component, or the optional third component; and
reacting the mixture to form the polyurethane acrylate hybrid composition.

10. A method of preparing a composite article, comprising:
disposing on a substrate or extruding through a die chamber, a polyurethane acrylic hybrid composition prepared by combining to form a mixture:
an isocyanate component including one or more isocyanate compounds;
an isocyanate-reactive component comprising one or more polyether polyols, wherein the isocyanate-reactive component has a viscosity of 600 cP or less;
an optional third component, and
a reinforcement material;
wherein one or more (meth)acrylate monomers having an acrylate functionality in the range of 2 to 8, and one or more initiators are, independently, present in at least one of the isocyanate component, the isocyanate-reactive component, or the optional third component;
curing the mixture to produce the composite article.
